(19) United States
(12) Patent Application Publication
(10) Pub. No.: US 2025/0350023 A1
(43) Pub. Date: Nov. 13, 2025

(54) ANTENNA FEED SHUNT FOR INACTIVE TRANSCEIVER ISOLATION IN WIRELESS RELAYS

(71) Applicant: GXC, LLC, Austin, TX (US)

(72) Inventors: Dean Zavadsky, Shakopee, MN (US); Ronald Radko, Kirkland, WA (US); Robert Wolfert, Scottsdale, AZ (US); Che-Chun Lin, Pflugerville, TX (US)

(21) Appl. No.: 19/204,365

(22) Filed: May 9, 2025

Related U.S. Application Data
(60) Provisional application No. 63/645,215, filed on May 10, 2024.

(51) Int. Cl. H01Q 3/24; H01Q 1/50; H01Q 1/52; H01Q 5/20; H04B 7/15

(52) U.S. Cl. CPC H01Q 3/24; H01Q 1/50; H01Q 1/528; H01Q 5/20; H04B 7/15

(57) ABSTRACT

A wireless communication relay device includes a first transceiver and a second transceiver, each configured to operate over respective communication channels. The channels of the relay device may be configured for co-channel operation or adjacent channel operation. The relay is configured to operate according to a time division multiplexing schedule such that only one transceiver is active (receiving or transmitting) during a given time interval. During inactive intervals, antenna feeds corresponding to inactive transceivers are shunted to ground using controllable RF switches. This antenna feed shunting prevents inactive transceivers from receiving power emitted into the local RF environment, including power emitted by the active transceiver or reflected by surrounding surfaces.

### CROSS-REFERENCE TO RELATED APPLICATION(S)

This application is a nonprovisional of, and claims the benefit under 35 U.S.C. § 119 of, U.S. Provisional Patent Application No. 63/645,215, filed on May 10, 2024, and entitled “Zero Interference Co-Channel Wireless Relay” the contents of which are incorporated by reference in its entirety.

### TECHNICAL FIELD

Embodiments described herein relate to wireless relay systems, and in particular, to relay systems with radio modules configured for co-channel and/or adjacent channel operation.

### BACKGROUND

Multi-channel wireless communication devices can include multiple transceiver modules, each operable in a transmit mode and a receive mode, and that may be configured for simultaneous or near-simultaneous operation in overlapping or adjacent channels.

However, in many environments, reflection(s) of transmitted signals from a transmit-operating transceiver module can become incident upon a receive-operating transceiver module of the same multi-channel wireless communication device. Further, as a result of physical proximity between multiple transceiver modules, power output of a transmit-operating transceiver module can trigger automatic gain control or other signal conditioning or noise filtering systems of a receive-operating transceiver module, decreasing performance thereof.

### SUMMARY

Embodiments described herein relate to a wireless relay device configured with a first transceiver module operable over a first channel and a second transceiver module operable over a second channel. The first and second channels may be adjacent channels or may have a co-channel relationship. Each transceiver is associated with a corresponding antenna feed and antenna connected through a respective controllable RF switch. A controller coordinates operation of the transceivers and switches according to a time division schedule.

In a first mode, during a first time interval, the controller activates the first transceiver, couples its antenna feed to its antenna, and shunts the second antenna feed to ground, leaving the second antenna floating or, in some cases, coupled to ground through a reactive load. In a second mode, during a second time interval following the first time interval, the controller activates the second transceiver, connects its respective feed to its antenna, and shunts the first antenna feed to ground (optionally shunting the first antenna to ground as well). The controller may alternate between these modes according to a predefined or adaptive schedule, ensuring that only one transceiver is active at a time, during which period the opposite transceiver and/or antenna is shunted to ground.

Each RF switch may be a multi-throw switch configured to of selectively couple an antenna feed to either an antenna or ground. The ground connection may take the form of a system ground or a grounded resistive load or other reactive or resistive load.

In some embodiments, the first transceiver provides wireless service to a user equipment device, while the second transceiver communicates with a base station. The first and second channels may partially overlap, and the transceivers may operate in compliance with different wireless protocols.

The controller may dynamically adapt the time division schedule in response to conditions in the local RF environment. In some configurations, both antenna feeds may be shunted to ground during inactive periods to prevent either transceiver from absorbing RF power.

The controller may include a processor configured to manage switch timing, and each antenna feed may be electrically isolated when inactive to prevent signal leakage or undesired coupling.

Further embodiments include methods of operating such a relay, including initiating a time interval for a first transceiver, shunting the second transceiver's antenna feed during that interval, then switching roles in a subsequent interval. These methods may include coupling and decoupling operations coordinated with a time division multiplexing schedule.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a wireless communications system including a wireless communications relay, such as described herein.

FIG. 2 is a timing diagram corresponding to operation of a wireless communications relay, as described herein.

FIG. 3 is a system diagram of a wireless communications relay, as described herein, operating in a multi-channel mode.

FIG. 4A is a system diagram of a wireless communications relay, as described herein, operating in a first single-channel receive mode.

FIG. 4B is a system diagram of the wireless communications relay of FIG. 4A, as described herein, operating in a first single-channel transmit mode.

FIG. 4C is a system diagram of the wireless communications relay of FIG. 4A, as described herein, operating in a second single-channel transmit mode.

FIG. 4D is a system diagram of the wireless communications relay of FIG. 4A, as described herein, operating in a second single-channel receive mode.

FIG. 5 is a simplified schematic diagram of a wireless communications relay as described herein.

FIG. 6 is a flowchart depicting example operations of a method of operating a wireless communications relay.

FIG. 7 is a flowchart depicting example operations of a method of operating a wireless communications relay.

FIG. 8 is a flowchart depicting example operations of a method of operating a wireless communications relay.

The use of the same or similar reference numerals in different figures indicates similar, related, or identical items.

Certain accompanying figures include vectors, rays, traces and/or other visual representations of one or more example paths—which may include reflections, refractions, diffractions, and so on, through one or more mediums—that may be taken by, or may be presented to represent, one or more photons, wavelets, or other propagating electromagnetic energy originating from, or generated by, one or more antennas shown or, or in some cases, omitted from, the accompanying figures. It is understood that these simplified visual representations of electromagnetic energy regardless of spectrum (e.g., radio, microwave, VHF, UHF, and so on), are provided merely to facilitate an understanding of the various embodiments described herein and, accordingly, may not necessarily be presented or illustrated to scale or with angular precision or accuracy, and, as such, are not intended to indicate any preference or requirement for an illustrated embodiment to receive, emit, reflect, refract, focus, and/or diffract light at any particular illustrated angle, orientation, polarization, or direction, to the exclusion of other embodiments described or referenced herein.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for eliminating and/or significantly attenuating self-interference in multichannel wireless communications systems. Specifically, embodiments described herein relate to small form factor (e.g., low physical isolation between transmit and receive antennas) wireless communications relays configured for operation in adjacent bands or the same band. For example, embodiments described herein relate to wireless communications relays (herein, simply, a “relay”) configured with at least two transceiver modules, each maintaining a communications channel with a respective one remote device, such as a user equipment (“UE”) device, another communications relay, a base station, other customer premises equipment (“CPE”), or the like.

More broadly, embodiments described herein relate to wireless communication relays (or other wireless communication devices) that include multiple transceiver modules, each of which may be transmit-operating or receive-operating at any given time. For simplicity of description, the embodiments herein are described with reference to a first transceiver module and a second transceiver module of a wireless relay. The first transceiver module and the second transceiver module each include at least one transmit chain (more simply, “transmitter”) and at least one receive chain (more simply, “receiver”), which may be coupled to different antenna fees or the same antenna feed (e.g., facilitated by modifying a state of a controllable RF switch on a schedule defined at least in part by one or more time division multiplexing techniques).

In one example, a wireless communication relay as described herein can be used to communicably couple local wireless subnetworks to backhaul (also referred to as core networks). For simplicity of description, many embodiments described herein reference a construction in which a wireless communication relay provides private cellular service to a region or over a coverage or service area and, additionally, wirelessly communicably couples to one or more other networks (which may include the open internet, a public switched telephone network, a private intranet, or other public or private network). In this manner, a wireless communication relay can be configured to communicably couple user equipments (“UE”) in the service area to core networks via a base station.

In one example, a wireless communication relay as described herein may be deployed in a warehouse environment in which public cellular networks may not reliably function and/or may not provide suitable information or access security controls. In this example, a first transceiver module of the wireless communication relay provides private cellular service access to UEs within the warehouse, while a second transceiver module communicably couples to a public cellular network external to the warehouse thereby bridging communications between user equipments within the warehouse to core networks. In an implementation of this example, the first transceiver module may be understood to support a private cellular network small cell (“SC”) and the second transceiver module may be understood to support communications with other CPE or base station devices, or, in other embodiments a gateway device in turn coupled via backhaul to a core network. For simplicity, in some examples, the first transceiver module may be referred to as an SC transceiver and the second transceiver module may be referred to as a gateway transceiver. In other embodiments, the terms first transceiver module and second transceiver module may be used.

It may be appreciated by a person of skill in the art that for a conventional wireless communication relay, simultaneous operation of the first transceiver module and the second transceiver module may interfere, especially if channels selected for communications are adjacent or shared.

More simply, it may be appreciated that any transceiver configured to communicate over a particular carrier frequency is likely to be coupled, via an antenna feed, to a physical antenna with carrier-frequency-defined or informed geometry. As such, if two separate transceiver devices are configured to operate over similar frequencies (as is the case for a relay device configured to operate over overlapping or adjacent channels), the two receivers will have identical or very similarly dimensioned antennas. As a result, energy emitted from one antenna system is easily absorbed by the other antenna system (conventionally described, the transmitted signal is “incident upon” the receiver device), often overpowering any recoverable signal with interference.

Furthermore, even for intervals over which one transceiver is neither transmitting nor receiving, power output of another transmit-operating transceiver may cause automatic gain control (“AGC”) or other signal conditioning systems or noise mitigation systems of the first transceiver to engage. Typically, such systems are implemented with timeout periods or designed hysteresis, and may still be engaged or tripped when the first transceiver enters a receive-operating mode. In these examples, engagement of AGC (and/or other automatic signal conditioning or noise reduction/mitigation systems) can significantly impact receive performance.

Moreover, in some cases, even transmit-configured inactive transceiver devices can be damaged may, overheat, or otherwise perform sub-optimally if transmit antennas receive/absorb power from the local environment.

To address these and other disadvantages of small formfactor conventional wireless relays configured with multiple radio systems required to operate in adjacent or identical channels, embodiments described herein relate to systems and methods for eliminating interference risk between transceivers by shunting inactive antenna feeds to ground, thereby isolating inactive transceivers, and time multiplexing communications between multiple communication channels.

More specifically, a relay device as described herein can be configured to subdivide available communications timeslots between individual channels and, more precisely, between transmit and receive modes of individual channels. More simply, a relay as described herein may be configured to operate with a site-specific time division multiplexing schedule (e.g., based on a number of devices within a service area operating on overlapping channels) such that the relay only performs one communication operation at a time, and only one transceiver of overlapping sets of transceivers is active at a time, configuring other transceivers to be inactive, isolated, with input/output antenna feeds shunted to ground.

For example, a relay having a first transceiver and a second transceiver communicating over channel A (herein abbreviated “CH-A”) and channel B (herein abbreviated “CH-B”) respectively with a UE device and a base station may be operable in four modes: a first mode in which the relay transmits over CH-A to the UE; a second mode in which the relay receives over CH-A from the UE; a third mode in which the relay transmits over CH-B to the base station; and a fourth mode in which the relay receives over CH-B to the base station.

In this example, the relay may be configured to operate in single mode at a time. More specifically, when transmitting over CH-A, the relay may neither be transmitting or receiving over CH-B. Similarly, when transmitting of CH-B, the relay may neither be transmitting nor receiving over CH-A. As used herein, channels and/or transceivers that are not in use during a given time slot may be referred to as “inactive.”

In this manner, continuing the previous example, the relay may be operable in four modes: a first mode in which the relay operates a first transceiver to transmit over CH-A to the UE and in which a second transceiver is inactive; a second mode in which the relay operates the first transceiver to receive over CH-A from the UE and in which the second transceiver is inactive; a third mode in which the relay operates the second transceiver to transmit over CH-B to the base station and in which the first transceiver is inactive; and a fourth mode in which the relay operates the second transceiver to receive over CH-B from the base station and in which the first transceiver is inactive.

Further to the foregoing timing pattern, embodiments described herein may be configured with antenna feed shunting switches that physically or electrically decouple an antenna or antenna array from a transceiver when that transceiver is inactive. More specifically, a shunting switch as described herein can be configured to couple an antenna feed of a receive chain to ground, thereby preventing an inactive receive chain from receiving any significant radio frequency (“RF”) power. In this manner, the inactive transceiver is physically and/or conductively isolated from any possible absorptive element (e.g., antenna hardware) of a suitable geometry that may otherwise absorb RF energy emitted by the other transceiver of the relay device.

In this manner, continuing the previous example, the relay may be operable in four modes: a first mode in which the relay operates a first transceiver to transmit over CH-A to the UE and in which a second transceiver is inactive and shunted to circuit, system, and/or earth ground; a second mode in which the relay operates the first transceiver to receive over CH-A from the UE and in which the second transceiver is inactive and shunted to ground; a third mode in which the relay operates the second transceiver to transmit over CH-B to the base station and in which the first transceiver is inactive and shunted to ground; and a fourth mode in which the relay operates the second transceiver to receive over CH-B from the base station and in which the first transceiver is inactive and shunted to ground.

In view of the foregoing more generally and broadly, embodiments described herein relate to systems and methods for shunting inactive antenna feeds to ground based on time division multiplexing schedules to prevent automatic engagement of, as an example, AGC.

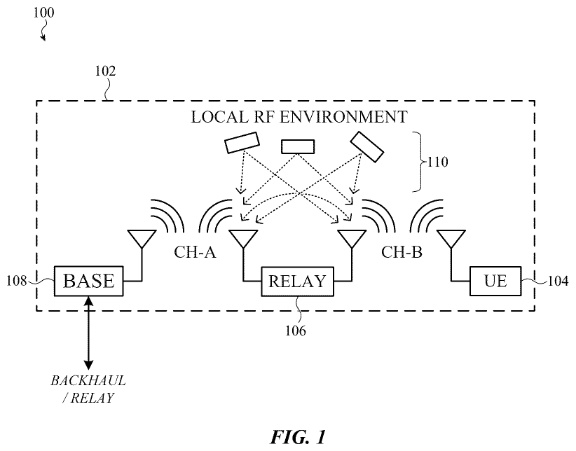

These foregoing and other embodiments are discussed below with reference to FIGS. 1-8. However, those skilled in the art will readily appreciate that the detailed description given herein with respect to these figures is for explanation only and should not be construed as limiting.

FIG. 1 depicts a wireless communications relay, such as described herein. In particular, the illustration depicts a wireless communications system 100 operating in a local RF environment 102.

The local RF environment 102 may be any radio environment; for simplicity of illustration and description, the local RF environment 102 may be within a building or large structure, such as a warehouse, mine, and the like. In other cases, the local RF environment 102 may be at least partially outdoors. These are merely examples; the local RF environment 102 may be any suitable environment.

The local RF environment 102 includes a user equipment 104 that wirelessly communicates with a multi-channel wireless relay device 106 that, in turn, is communicably coupled via a base station 108 to one or more core networks. This topology facilitates wireless communication within the local RF environment 102 between the user equipment 104 and the core network(s), without requiring that the user equipment 104 is within the service area or coverage area of the base station 108.

The user equipment 104 can be any suitable portable or stationary user equipment device. In some cases, the user equipment 104 is a cellular phone or wearable device whereas in other embodiments the user equipment 104 is a Wi-Fi capable device. The user equipment 104 may be a stationary electronic device, such as warehouse equipment or manufacturing appliances or controls. For simplicity of description, the user equipment 104 may be presumed to be a cellular capable device such as a cellular phone, although it may be appreciated that this is merely one example.

The multi-channel wireless relay device 106 can be configured with multiple radios (also referred to herein as “transceivers”), each of which may be configured to conform to one or more wireless communication protocols and operate over one or more channels associated with a given carrier frequency. A first transceiver of the multi-channel wireless relay device 106 can be configured to communicably couple to the user equipment 104 and a second transceiver of the multi-channel wireless relay device 106 can be configured to communicably couple to the base station 108.

In some deployments, the first and second transceivers of the multi-channel wireless relay device 106 can be configured to operate in non-overlapping bands. In these examples, self-interference is likely to be minimal and thus any self-interference cancellation circuitry or processing components may be disabled to save power.

However, as noted above, the first and second transceivers of the multi-channel wireless relay device 106 can be configured to operate in adjacent or overlapping bands. In these examples, the first transceiver can be configured in one time interval to transmit or receive over a first channel while the second transceiver is configured to transmit or receive over a second channel close in spectrum to the first channel. In the illustrated example, the multi-channel wireless relay device 106 communicates with the base station 108 via CH-A and the user equipment 104 communicates with the multi-channel wireless relay device 106 over CH-B.

Due to spectral proximity of CH-A and CH-B, the first transceiver and the second transceiver may, as noted above, mutually interfere as a result of reflections within the local RF environment 102, such as reflections that may be contributed by the reflection sources 110. Reflections from these reflective objects within the local RF environment 102 cooperate to introduce self-interference incident upon the first transceiver (when transmitting from the second transceiver) and self-interference incident upon the second transceiver (when transmitting form the first transceiver). More specifically, sideband content of CH-A when a radio transmitting in CH-A may overlap with CH-B and likewise the inverse.

It may be appreciated that “adjacent” as used herein in respect of communication channels defined by center frequencies/carriers, can vary from embodiment to embodiment and implementation to implementation. More generally and broadly, a first channel may be considered adjacent to a second channel if a nontrivial sideband power of the first channel overlaps with the second channel; as may be appreciated, standard-defined channel separations can inform whether overlap/interference is more or less likely to occur. In many cases, as may be appreciated by a person of skill in the art, standards-defined channels often overlap one another by design. As such, as used herein the term “adjacent” channels may be understood to be relative to a particular pair of communication standards supported by a given wireless communications relay and, in respect of those standards, whether the channels (carriers) and the bandwidth supported therein are likely to induce nontrivial sideband power overlaps necessitating or motivating self-interference cancellation.

Further, it may be appreciated that embodiments described herein can be leveraged in co-channel deployments as well. In particular, it may be appreciated that “co-channel” as used herein in respect of communication channels defined by center frequencies or carriers, refers generally to two or more communication signals that are allocated the same nominal frequency or a substantially overlapping frequency range. As such, co-channel operation may arise between distinct transmitters-such as between neighboring wireless base stations, relay nodes, or user devices-configured to operate over a shared spectrum allocation . . . . In some embodiments, “co-channel operation” may further be understood to include overlapping bandwidths where the intended signal bands coincide, even if originating from different communication standards or protocols.

As a simple example, a first communication standard may define ten usable channels separated by 25 MHz, starting at approximately 2.4 GHz (or 2400 MHZ). A second communication standard may define ten usable channels separated by 100 MHz starting approximately at 2.5 GHz or 2500 MHz. In this example, among several channel overlaps, it may be appreciated that the first channel of the second communication standard overlaps at least in part several higher-index channels of the first communication standard.

Continuing the previous example, when a first transceiver transmitting over Channel 10 of the first communication standard, that transmission may be incident upon a second transceiver receiving over Channel 1 of the second communication standard, constituting noise therefor. Similarly, as the second transceiver transmits over Channel 1 of the second communication standard as the first transceiver enters a receive interval in Channel 10, the second radio's transmissions constitute noise and interference in respect of the first transceiver. For configurations in which the first transceiver and the second transceiver are components of the same wireless communications relay (such as the multi-channel wireless relay device 106), or otherwise co-located or associated with the same communication system or network, these overlapping transmissions constitute direct self-interference in respect of the operation of the multi-channel wireless relay device 106 itself.

In addition, as noted above, each transmission in an overlapping or adjacent band can also induce echo channel-self-interference. Specifically, as the first transceiver transmits into a local RF environment (e.g., the local RF environment 102) in a selected channel conforming to a first communication standard, that transmission can be reflected by one or more reflective surfaces within that environment (e.g., the reflection sources 110). Some of these reflections may, at different relative delays and attenuations, become incident upon the second transceiver interfering with its operation.

As noted above, in more typical configurations, the wireless communications system 100 can be configured to operate within the local RF environment 102 in adjacent bands or, in some embodiments, may be configured for co-channel operation. For example, the base station 108 can be configured to operate according to a first protocol or standard that leverages CH-A and the user equipment 104 can be configured to operate according to a second protocol or standard that leverages CH-B, which may at least partially overlap with CH-A.

For example, the multi-channel wireless relay device 106 can be configured to implement a timing schedule in which only one of the first or second transceivers is active during any given communications interval. When a first transceiver of the multi-channel wireless relay device 106 is operating in a transmit or receive mode over CH-A to or from the base station 108, the second transceiver configured to operate over CH-B is rendered inactive and its antenna feed shunted to ground, effectively disconnecting receive and transmit chains of that transceiver from any absorptive antenna elements. In this manner, in this configuration, the inactive transceiver is effectively decoupled from the radio frequency energy present in the local RF environment 102, including reflections from the reflection sources 110 and emissions of the first transceiver or the base station 108.

In a subsequent timeslot, the second transceiver may operate to transmit or receive over CH-B to or from the user equipment 104, during which the first transceiver is rendered inactive and similarly shunted to ground.

In each of the operational modes of the multi-channel wireless relay device 106, inactive transceivers are isolated from their corresponding antennas by way of a controllable switch network configured to selectively couple the inactive transceiver's antenna feed to a suitable ground. This physical and/or electrical disconnection from the antenna system mitigates risks associated with reception of high power signals, including unintentional triggering of automatic gain control systems, thermal overload, or deterioration of signal-to-noise ratios in subsequent active modes which may, in some cases, be due to continued operation of AGC systems (as an example).

For example, when the first transceiver is transmitting to the base station 108, reflections within the local RF environment 102 may be incident upon antennas of the inactive second transceiver. In addition, power output from the first transceiver may be directly incident upon antennas of the inactive second receiver. By shunting the antenna feed (e.g., receive and/or transmit chain output ports that, in turn, couple to radiative or absorptive antenna elements) of the second transceiver to ground, the system prevents these reflections and directly incident power from being absorbed into receive and/or transmit chains of the second transceiver, thereby eliminating risks of interference and/or damage to or lasting performance degradations of the second transceiver.

In some embodiments, the controllable switch network of the multi-channel wireless relay device 106 can include one or more RF switches that are disposed between individual transceiver ports and associated antenna feed points. These switches may be configured to operate under digital or analog control, such as via a microcontroller or processor associated with the multi-channel wireless relay device 106. In operation, these switches may be actuated to establish a conductive path to ground for inactive antenna feeds, and may be opened to restore normal antenna-transceiver connectivity during designated active intervals. In other cases, the switches may have multiple poles, coupling antenna feeds to ground in one mode and connecting antenna feeds to antennas in another mode. Many configurations are possible.

In some embodiments, the ground reference used for shunting inactive transceiver chains may be a dedicated circuit ground plane, a system chassis ground, or an earth-referenced ground connection. Impedance and/or reactance of the shunting path may vary from embodiment to embodiment and/or application to application.

The timing schedule that determines which transceiver is active at any given time may be statically defined or may be adaptively computed/selected/assigned in real time. In adaptive implementations, one or more environmental sensing modules or channel condition monitors of the multi-channel wireless relay device 106 may periodically assess power levels, signal quality metrics, or estimated reflection coefficients associated with the local RF environment 102. Based on these measurements, the timing controller may adjust time slot allocations or alter the sequence of transceiver activation and inactivation to maintain reliable connectivity and bandwidth to all coupled devices.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

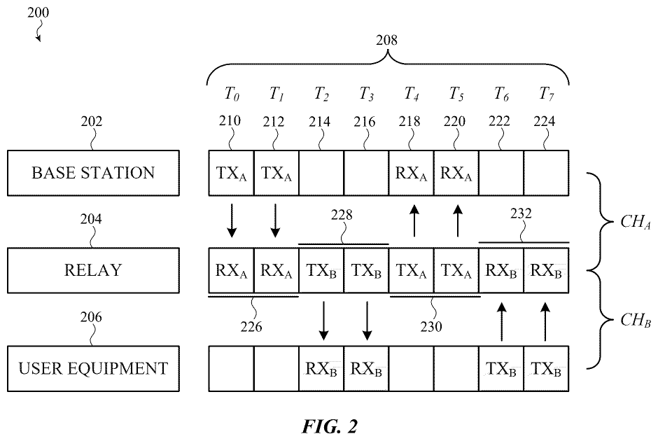

FIG. 2 depicts a wireless communication timing diagram 200 representing a relay-based communication system as described herein operating across two overlapping communication channels, illustrated in FIG. 2 as CH-A and CH-B. As with other embodiments described herein, the system includes a base station 202, a relay 204, and a user equipment 206. The communication activity among these devices is scheduled according to a time-division multiplexing schedule 208 that, in this example, is defined by the time intervals 208, labeled as T₀ through T₇ and as the time intervals 210-224. It may be appreciated that although eight divisions are shown, this is merely one (arbitrary) example. In other cases, timing may be divided in another manner.

As shown, a first communication interval corresponding to time intervals T₀ and T₁ (depicted in FIG. 2 as time intervals 210, 212), the base station 202 transmits data to the relay 204 over CH-A. During this interval, a CH-A transceiver of the relay 204 operates in receive mode while a CH-B transceiver of the relay 204 is entirely inactive, with an antenna feed thereof shunted to ground. More specifically, the CH-B tuned transceiver device antenna feeds of the relay 204 are shunted to ground, isolating both transmit and receive chains of the CH-B transceiver from the local RF environment, including from power emitted from the base station 202. The user equipment 206 is inactive throughout this interval and performs no transmit or receive operations.

At a second communication interval corresponding to time intervals T₂ and T₃ (depicted as time intervals 214 and 216), the relay 204 transmits to the user equipment 206 over CH-B. As described in respect of other operations, modes, and embodiments referenced herein, during this interval, the CH-A transceiver of the relay 204 is inactive, and the CH-A antenna feeds are shunted to ground, thereby isolating the CH-A transceiver in the same manner as the CH-B transceiver was isolated in the first communication interval. The user equipment 206 operates in receive mode over CH-B and the base station 202 is inactive.

Likewise, a third communication interval corresponding to time intervals T₄ and T₅ (depicted as time intervals 218 and 220), the relay 204 transmits to the base station 202 over CH-A. During this interval, the CH-A transceiver of the relay 204 operates in transmit mode while the CH-B transceiver is disabled and shunted to ground. The base station 202 operates in receive mode over CH-A, and the user equipment 206 remains inactive.

In a fourth communication interval corresponding to time intervals T₆ and T₇ (depicted as time intervals 222 and 224), the user equipment 206 transmits to the relay 204 over CH-B. The CH-B transceiver of the relay 204 operates in receive mode, while the CH-A transceiver is disabled and its antenna feeds are shunted to ground. The base station 202 is inactive throughout this interval.

For clarity, FIG. 2 includes indicators corresponding to communication channels that are effectively shunted by operation of a switch network or other antenna feed shunting circuitry or components, as described herein. In particular, a shunted channel indicator 226 represents time intervals during which the CH-B transceiver of the relay 204 is inactive and its antenna feeds are shunted to ground. Specifically, during time intervals T₀ and T₁, the CH-A transceiver of the relay 204 is active in receive mode while the CH-B transceiver is disabled and electrically isolated.

A shunted channel indicator 228 represents time intervals during which the CH-A transceiver of the relay 204 is inactive and its antenna feeds are shunted. In this interval, specifically during time intervals T₂ and T₃, the CH-B transceiver is active in transmit mode to the user equipment 206 while the CH-A transceiver is disabled.

A shunted channel indicator 230 represents time intervals T₄ and T₅, during which the CH-B transceiver of the relay 204 is again shunted and inactive while the CH-A transceiver operates in transmit mode to the base station 202. A shunted channel indicator 232 indicates time intervals T₆ and T₇, during which the CH-A transceiver of the relay 204 is shunted and inactive while the CH-B transceiver receives transmissions from the user equipment 206.

These foregoing embodiments depicted in FIG. 2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

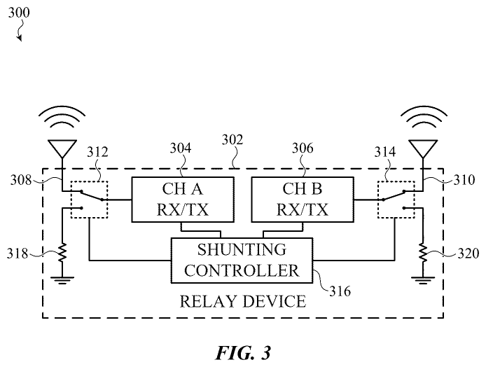

FIG. 3 depicts a relay system architecture 300 a relay device 302 configured with independently operable transceiver modules. A transceiver module 304 is tuned to operate over CH-A, and a transceiver module 306 is tuned to operate over CH-B. Each transceiver module may include one or more transmit and receive chains, each coupled to a corresponding antenna path via a switching structure that selectively connects or isolates the antenna path under control of a switching and shunting subsystem, such as described herein.

A first antenna 308 is associated with the transceiver module 304 and is connected via a first RF switch 312. A second antenna 310 is associated with the CH-B transceiver module 306 and is connected via a second RF switch 314. The first RF switch 312 and the second RF switch 314 are each controllably operable to connect or disconnect their respective antenna feeds from each respective transceiver (e.g., the transceiver modules 304, 306). Each switch may additionally be operable to couple the antenna feed to a grounding element, such as a resistor network or direct path to circuit ground.

A shunting controller 316 is coupled to both the first RF switch 312 and the second RF switch 314 and is configured to selectively control states of the RF switches in accordance with a predefined or adaptive time division multiplexing schedule. For example, when the transceiver module 304 is inactive, the shunting controller 316 directs the first RF switch 312 to isolate the transceiver module 304 and connect the transceiver module 304 to a first shunting network 318. Likewise, when the transceiver module 306 is inactive, the shunting controller 316 operates the second RF switch 314 to isolate the transceiver module 306 by coupling the transceiver module 306 to a second shunting network 320.

The first shunting network 318 and the second shunting network 320 may be resistive loads, grounded switches, matched terminations, or equivalent circuit elements. These paths may be implemented to provide low-impedance discharge to ground and/or to reduce or eliminate received power. The shunting controller 316 may be implemented as a discrete logic controller, a microcontroller subsystem, or as a functional module of a system-on-chip including timing and scheduling logic.

These foregoing embodiments depicted in FIG. 3 and the various alternatives thereof and variations thereto are presented, generally, for purposes of explanation, and to facilitate an understanding of various configurations and constructions of a relay device, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

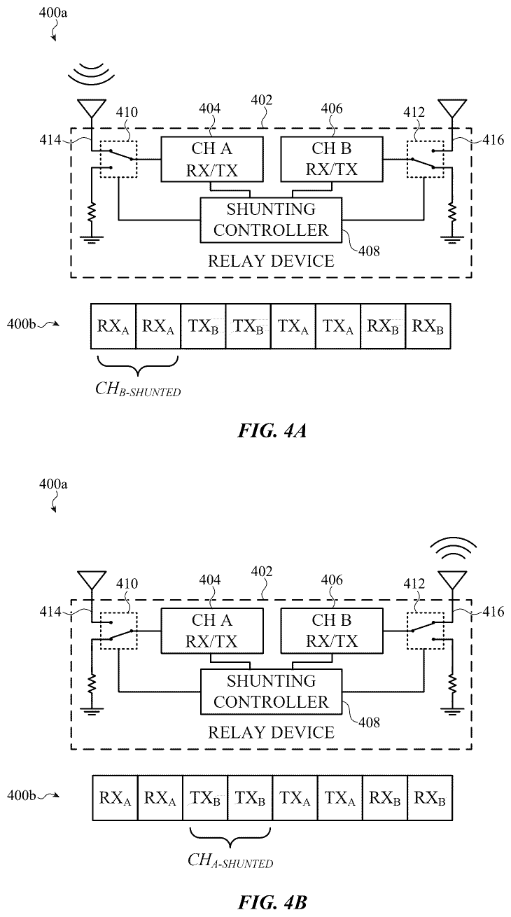

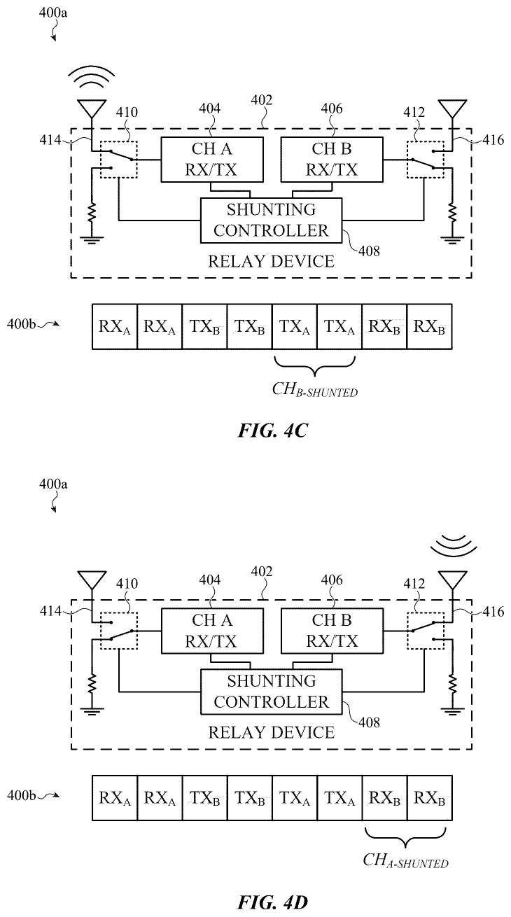

FIGS. 4A-4D illustrate a series of example relay device configurations 400a and corresponding timing diagrams 400b that depict different discrete states of antenna shunting based on a channel-specific transceiver schedule.

A relay device 402 includes a CH-A transceiver module 404 and a CH-B transceiver module 406. A shunting controller 408 is communicably coupled to each of the transceiver modules and configured to control switch states according to an active/inactive transceiver schedule.

In each of the illustrated configurations, a first antenna 414 is associated with the CH-A transceiver module 404 and is connected thereto via a first RF switch 410. Likewise, a second antenna 416 is associated with the CH-B transceiver module 406 and is connected via a second RF switch 412. The first RF switch 410 and the second RF switch 412 are each operable to connect a respective transceiver to its antenna feed or, alternatively, to decouple the antenna feed and connect the transceiver to ground thereby isolating the transceiver from RF energy of the local environment.

FIG. 4A shows a first configuration in which the CH-A transceiver module 404 operates in receive mode, and the CH-B transceiver module 406 is inactive. In this configuration, the shunting controller 408 drives the second RF switch 412 to couple the CH-B transceiver module 406 to ground, isolating it from the local RF environment. The first RF switch 410 is operated to couple the CH-A transceiver module 404 to the first antenna 414. The timing diagram 400b below indicates the CH-B transceiver is shunted during the first two intervals, consistent with the CH-A transceiver operating, in this example, in a receive mode.

FIG. 4B shows a second configuration in which the CH-B transceiver module 406 operates in transmit mode, and the CH-A transceiver module 404 is inactive. In this configuration, the shunting controller 408 drives the first RF switch 410 to isolate the CH-A transceiver module 404 and connect it to ground via a termination network. The second RF switch 412 is closed to couple the CH-B transceiver module 406 to the second antenna 416. As shown in the timing diagram 400b, the CH-A channel is shunted during the third and fourth intervals, while the CH-B transceiver is transmitting.

FIG. 4C depicts a third configuration in which the CH-A transceiver module 404 resumes activity, shown here in transmit mode, and the CH-B transceiver module 406 is again rendered inactive. The first RF switch 410 is closed, and the second RF switch 412 is opened and routed to ground. This configuration corresponds to the fifth and sixth intervals of the timing diagram 400b, where CH-B transceiver electronics are shunted and CH-A transceiver electronics are active.

FIG. 4D shows a fourth configuration in which the CH-B transceiver module 406 operates in receive mode, while the CH-A transceiver module 404 is inactive and shunted. The second RF switch 412 is closed to enable reception by the CH-B transceiver, and the first RF switch 410 is opened and coupled to ground to isolate the CH-A transceiver. This configuration corresponds to the final two time intervals in the timing diagram 400b, where CH-A is shunted.

Each of the switch configurations illustrated in FIGS. 4A-4D demonstrates enforcement of single-channel transceiver activity and shunting of the inactive channel electronics (e.g., receive chains, transmit chains, and so on) to ground, consistent with time-division operation principles and isolation principles described herein. The shunting controller 408, which may be implemented in firmware or hardware, alternates the RF switch states based on predefined time slot allocation or real-time environmental metrics.

These foregoing embodiments depicted in FIGS. 4A-4D and the various alternatives thereof and variations thereto are presented, generally, for purposes of explanation, and to facilitate an understanding of various configurations and constructions of a relay device, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, although FIGS. 4A-4D each reference configurations in which RF switches are controlled by timing controllers that are integrated with other control electronics of the respective relay device. This may not be required of all embodiments. For example, in some configurations, antenna shunting switches can be electrically/communicatively integrated with CH-A or CH-B radios of the relay, or may run completely independently, so long as frame timing can be established or recovered, such as by operation or leverage of a Network Listen receiver, or through GPS timing.

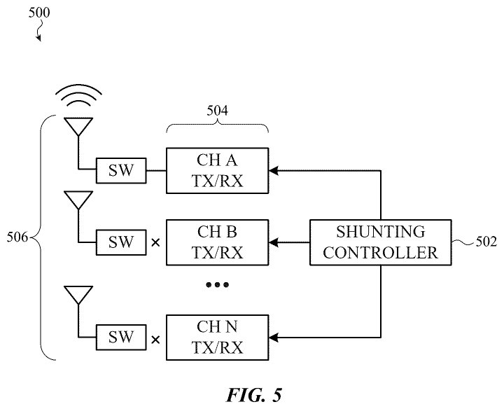

FIG. 5 depicts a multi-channel shunting relay system 500 including a shunting controller 502 and a set of transceiver modules 504, each of which may be independently controlled in accordance with a defined time-division schedule as described herein. In the example shown, the system includes N transceiver modules, each configured for operation over a distinct communication channel that may overlap. Each transceiver may include one or more transmit and/or receive chains configured to operate over a respective carrier frequency or within a selected frequency band.

As with other embodiments describe herein, each of the transceiver modules 504 are individually coupled to corresponding antennas 506. Each antenna is further associated with a respective RF switch. Each switch is operable under control of the shunting controller 502 to selectively couple its corresponding transceiver to the associated antenna or to a termination path. In the example shown, as with other embodiments described herein, two of the three depicted transceiver-antenna paths are disabled and shunted, while one transceiver path remains active and coupled to its antenna.

In operation, the shunting controller 502 determines which transceiver module of the set 504 is active in a given interval and correspondingly directs the remaining transceivers to enter an inactive state. For each inactive transceiver, the shunting controller 502 actuates the associated RF switch to isolate the transceiver from its antenna feed and couple the antenna feed to a termination path, such as a grounded resistive load. This ensures that inactive transceivers are not exposed to incident power from the local RF environment and are conductively isolated from active paths operating at adjacent or overlapping frequencies or configured for co-channel operation.

These foregoing embodiments depicted in FIG. 5 and the various alternatives thereof and variations thereto are presented, generally, for purposes of explanation, and to facilitate an understanding of various configurations and constructions of a relay device, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, in many embodiments, a system or relay as described herein may be configured through pre-provisioning of time division duplexing (TDD) frame patterns. It may be appreciated however that the embodiments described herein can be extended to support frequency division duplexing (FDD) radio systems operating in paired spectrum by time-scheduling respective transmissions. Further, similar scheduling concepts may be applicable to TDD systems may be applied to FDD systems in this context.

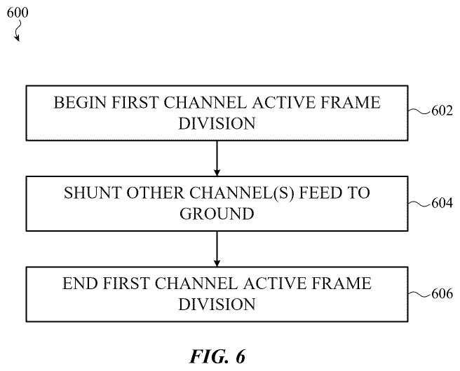

FIG. 6 illustrates a flowchart corresponding to a method 600 for isolating a first communication channel of a wireless communication relay device. At operation 602, the relay begins an active frame division for a first channel. This interval corresponds to a time slot during which a transceiver module associated with the first channel is permitted to operate in either a transmit or receive mode.

At operation 604, during the active interval for the first channel, antenna feeds corresponding to all other channels are shunted to ground. This shunting operation isolates transceivers not participating in the current communication interval and prevents signal energy from the active channel from coupling into inactive transceiver modules.

At operation 606, the method concludes the first channel active frame division. Upon completion of this time slot, the transceiver module associated with the first channel is rendered inactive and subsequent frame division logic or scheduling logic may proceed to activate another channel.

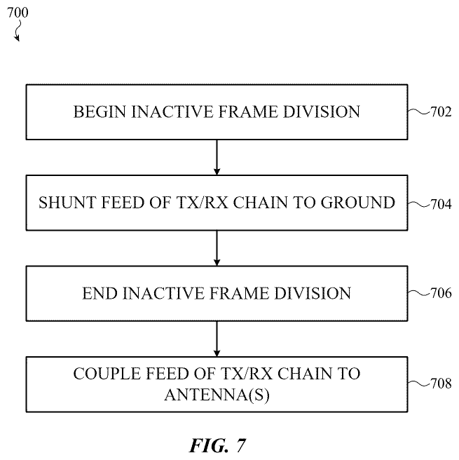

FIG. 7 illustrates a method 700 for managing an inactive frame division for a transceiver module of a wireless relay device. At operation 702, the system begins an inactive frame division. In this configuration, the transceiver corresponding to the inactive interval is not participating in transmission or reception operations.

At operation 704, the feed of a transmit/receive chain corresponding to the inactive transceiver is shunted to ground. As noted with respect to other embodiments described herein, this operation effectively decouples the transceiver from the antenna system, protecting it from receiving or emitting unintended energy during this inactive period.

At operation 706, the inactive frame division interval ends. At operation 708, the antenna feed may thereafter then re-couple to the transceiver in preparation for the next active interval. This transition restores operability of the transceiver for its upcoming transmit or receive operations and/or time intervals.

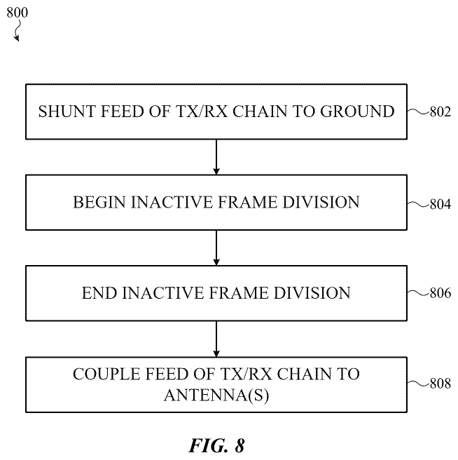

FIG. 8 illustrates an alternative method 800 for managing antenna feed control during an inactive transceiver interval. At block 802, the system initially shunts the feed of the TX/RX chain to ground. This operation is performed prior to the start of the inactive interval and serves to isolate the transceiver from the local RF environment.

At operation 804, the system begins the inactive frame division. Throughout this time, the transceiver remains electrically decoupled from the antenna by way of the grounded shunt path, protecting it from interference or unintentional activation.

At operation 806, the system ends the inactive frame division. Finally, at block 808, the feed of the TX/RX chain is coupled to its antenna, reestablishing full communication capability in advance of any subsequent active frame divisions.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

As described herein, the term “memory” refers to any software and/or hardware-implemented data storage device or circuit physically and/or structurally configured to store data in a non-transitory or otherwise nonvolatile, durable manner. This term is meant to encompass memory devices, memory device arrays (e.g., redundant arrays and/or distributed storage systems), electronic memory, magnetic memory, optical memory, and so on.

What is claimed is:

1. A wireless relay device comprising:
a first transceiver module configured to communicate over a first channel and comprising a first antenna feed;
a second transceiver module configured to communicate over a second channel comprising a second antenna feed;
a first antenna;
a second antenna;
a first controllable switch coupled between the first antenna feed and the first antenna;
a second controllable switch coupled between the second antenna feed and the second antenna; and
a controller configured to:
in a first mode:
operate the first controllable switching during a first time interval to couple the first antenna to the first antenna feed;
operate the first transceiver module during the first time interval; and
operate the second controllable switch during the first time interval to shunt the second antenna feed to ground; and
in a second mode:
operate the second controllable switching during a second time interval to couple the second antenna to the second antenna feed;
operate the second transceiver module during the second time interval; and
operate the first controllable switch during the second time interval to shunt the first antenna feed to ground; and
operate the second transceiver module during a second time interval while shunting the first antenna feed to ground via the first controllable switch.

2. The wireless relay device of claim 1, wherein each controllable switch is configured to switch between a connection to a respective one antenna feed and a connection to ground.

3. The wireless relay device of claim 1, wherein the controller is configured to alternate between the first mode and the second mode.

4. The wireless relay device of claim 1, wherein the first transceiver module is configured to provide wireless service to a user equipment device, and the second transceiver module is configured to communicate with a base station device.

5. The wireless relay device of claim 1, wherein the ground comprise a system ground.

6. The wireless relay device of claim 1, wherein the second channel overlaps at least partially in frequency with the first channel.

7. A method of operating a wireless relay device comprising a first transceiver and a second transceiver, the method comprising:
initiating a first active frame interval for the first transceiver;
shunting a second antenna feed of the second transceiver to ground during the first active frame interval;
ending the first active frame interval for the first transceiver;
initiating a second active frame interval for the second transceiver; and
shunting a first antenna feed of the first transceiver to ground during the second active frame interval.

8. The method of claim 7, further comprising coupling the second antenna feed of the second transceiver to an antenna array after ending the first active frame interval.

9. The method of claim 7, wherein the shunting comprises electrically coupling an antenna feed to a grounded resistive load.

10. A wireless relay system comprising:
a first antenna;
a second antenna;
a first RF switch coupled to the first antenna and a first transceiver;
a second RF switch coupled to the second antenna and a second transceiver;
a controller configured to operate the first RF switch and the second RF switch according to a time division schedule such that:
only one of the first or second transceivers is coupled to its respective antenna during a given time interval; and
a respective antenna feed of the other respective transceiver is shunted to ground during the given time interval.

11. The wireless relay system of claim 10, wherein the controller is further configured to adapt the time division schedule based on a local RF environment.

12. The wireless relay system of claim 10, wherein the first transceiver and the second transceiver are configured to operate over channels associated with different wireless communication protocols.

13. The wireless relay system of claim 10, wherein the controller is configured to shunt both the first antenna feed to ground during an inactive frame interval associated with the first transceiver.

14. The wireless relay system of claim 10, wherein each RF switch is a multi-throw switch operable to selectively couple a corresponding antenna feed to one of the first antenna or second antenna, one of the first transceiver or the second transceiver, or ground.

15. The wireless relay system of claim 10, wherein the first transceiver is configured to operate over a cellular protocol.

16. The wireless relay system of claim 10, wherein the controller comprises a processor configured to control each RF switch.

17. The wireless relay system of claim 10, wherein each antenna feed is coupled to ground through a resistive load when shunted.

18. The wireless relay system of claim 10, wherein the controller is configured to determine the time division schedule at least in part based on a local RF environment.

19. The wireless relay system of claim 10, wherein the first transceiver and the second transceiver are configured to operate on adjacent channels within a shared frequency band.

20. The wireless relay system of claim 10, wherein the controller is configured to change a state of the first RF switch and the second RF switch between time intervals defined by a time division multiplexing schedule.
